(19) United States
(12) Patent Application Publication
(10) Pub. No.: US 2004/0237899 A1
(43) Pub. Date: Dec. 2, 2004

(54) Chew-resistant pet bed

(76) Inventor: Bryan Fung, San Jose, CA (US)

Correspondence Address: HAVERSTOCK & OWENS LLP, 162 NORTH WOLFE ROAD, SUNNYVALE, CA, 94086, US

(21) Appl. No.: 10/843,804

(22) Filed: May 11, 2004

Related U.S. Application Data
(60) Provisional application No. 60/469,222, filed on May 12, 2003.
(60) Provisional application No. 60/473,399, filed on May 28, 2003.

(51) Int. Cl. A01K 29/00

(52) U.S. Cl. 119/28.5

(57) ABSTRACT

A chew-resistant pet bed is disclosed comprising a mattress, a plurality of rims, and a plurality of spherical joints. The mattress comprises a plurality of insert sections. The components of the pet bed are preferably configured to be integrally molded and comprise a chew-resistant homogeneous resilient non-toxic bitter material. In alternative embodiments, the components of the pet bed are configured to detachably couple to one another and comprise a chew-resistant homogeneous resilient non-toxic bitter material. Preferably, the chew-resistant pet bed ranges in size such that the pet bed will fit within 24-54 inch deep dog shipping crates. Preferably, at least one of the plurality of insert sections comprise cloth; in other embodiments, at least one of the plurality of insert sections comprise a chew-resistant non-toxic non-bitter material pet toy, a plurality of bristles, or a combination thereof.

### RELATED APPLICATION

This application claims priority under 35 U.S.C. § 119(e) of the co-pending U.S. Provisional Application Ser. No. 60/469,222, filed on May 12, 2003, and titled “CHEW RESISTANT DOG BED,” and the co-pending U.S. Provisional Application Ser. No. 60/473,399, filed on May 28, 2003, and titled “CHEW RESISTANT DOG BED.” The Provisional Application Ser. No. 60/469,222, filed on May 12, 2003, and titled “CHEW RESISTANT DOG BED” and the Provisional Application Ser. No. 60/473,399, filed on May 28, 2003 and titled “CHEW RESISTANT DOG BED” are hereby incorporated by reference.

### FIELD OF THE INVENTION

The present invention relates to the field of pet beds. More particularly, the present invention relates to chew-resistant pet beds.

### BACKGROUND OF THE INVENTION

Pet owners have many choices for pet beds. The most common pet beds are those which are stuffed with wood shavings or batting surrounded by a cloth shell. Other beds are made with a PVC frame and a support surface. In such beds, the PVC frame can be damaged or broken and does not easily fit into dog crates and carriers. The non-resilient surfaces of current pet beds are chewable by pets. For example, current plush pet beds are susceptible to being chewed by pets, are shredded, and may be swallowed by the pets causing severe discomfort and possibly requiring surgery.

### SUMMARY OF THE INVENTION

A chew-resistant pet bed is designed to fit in standard dog shipping crates. The preferred chew-resistant pet bed comprises a mattress, a plurality of joints, and a casing. The mattress preferably comprises a plurality of built-in insert section openings that receive equally durable insert sections and accessories designed especially for the bed, such as cloth, rubber bristles, or a chew-resistant toy, for example and which provide a balance of chew-resistance and comfort. The plurality of joints are preferably in a spherical configuration. In other embodiments, the plurality of joints are each molded into larger bulbous rims which have hollow cores to increase tensile strength should the pet chew on its edges. Regardless of the embodiment, the pet bed preferably comprises a chew-resistant homogeneous resilient non-toxic bitter material providing a safe, comfortable, and chew-resistant resting surface for pets.

### BRIEF DESCRIPTION OF THE DRAWINGS

FIG. 1 illustrates an isometric view of a integrated chew-resistant pet bed, in accordance with the instant invention.

FIG. 2A illustrates an isometric view of a mattress of a chew-resistant pet bed, in accordance with the instant invention.

FIG. 2B illustrates an isometric view of the chew-resistant pet bed mattress illustrated in FIG. 1A with a plurality of rims and a plurality of spherical joints, in accordance with the instant invention.

FIG. 2C illustrates a fully assembled chew-resistant pet bed, with the components illustrated in FIGS. 1A and 1B, in accordance with the instant invention.

FIG. 3 illustrates an isometric view of a chew-resistant pet bed, in accordance with the instant invention.

FIG. 4 illustrates an isometric view of an insert section comprising rubber bristles, in accordance with the instant invention.

FIG. 5 illustrates an isometric view of an insert section comprising cloth, in accordance with the instant invention.

FIG. 6A illustrates a front view of an insert section comprising a pet toy, in accordance with the instant invention.

FIG. 6B illustrates an isometric view of an insert section comprising a pet toy, in accordance with the instant invention.

### DETAILED DESCRIPTION OF THE INVENTION

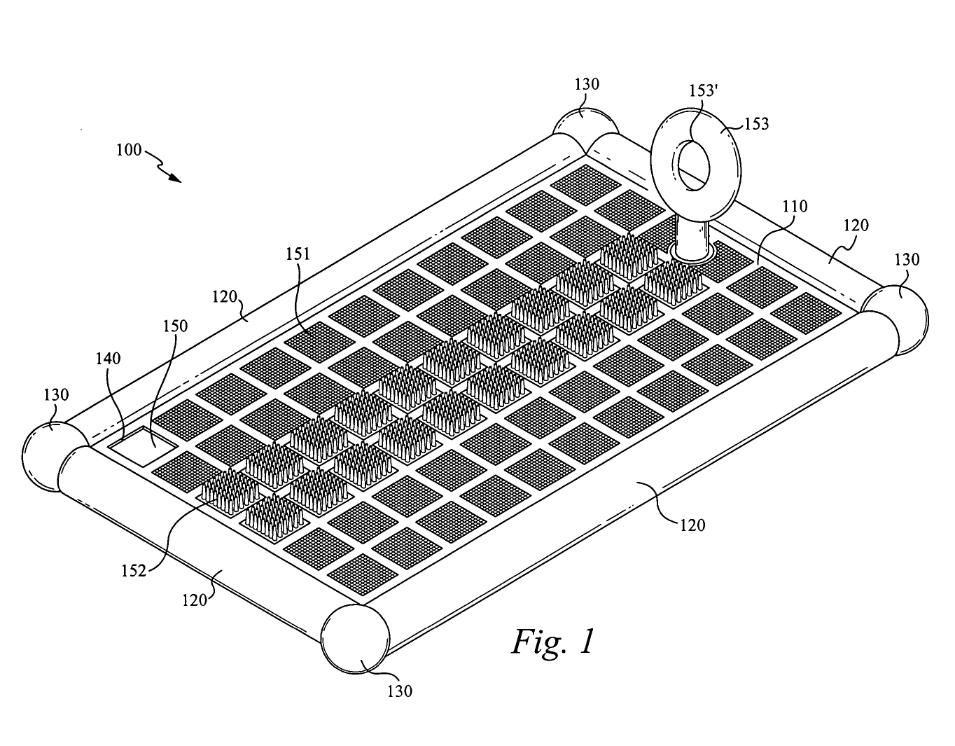

The preferred embodiment of the current invention is illustrated in FIG. 1. Specifically, an integral pet bed 100 is disclosed. The integral pet bed 100 comprises a molded mattress 110, a molded frame 120, and a plurality of molded joints 130. Preferably, the molded mattress 110, the molded frame 120, and each of the plurality of molded joints 130 comprise a homogenous non-toxic bitter chew-resistant resilient material and are molded to form the integral pet bed. It should be understood that integral means one-piece. In other words, the molded mattress 110, the molded frame 120, and each of the plurality of molded joints 130 are molded together to form the one-piece integral pet bed 100. In addition, the molded mattress, the molded frame, and each of the plurality of molded joints of the preferred integral pet bed 100 comprise a hollowed core (not shown). Preferably, the molded mattress 110 further comprises a plurality of holes 140 each comprising a molded insert 150. The preferred molded insert 150 comprises cloth 151 (discussed below). However, in alternative embodiments, at least one of the molded insert 150 comprises rubber bristles 152 (discussed below), or at least one of the molded insert 150 comprises a pet toy 153 (described below) configured to detachably couple to at least one of the plurality of holes 140, or at least one of the molded insert 150 comprises cloth 151, rubber bristles 152, a pet toy 153, or a combination thereof. Preferably, the pet toy 153 comprises a homogenous non-toxic non-bitter chew-resistant resilient material and a hole 153′ configured to hold a pet treat (not shown). Examples of the pet treat include, but are not limited to a food product or a chewable toy. In alternative embodiments, the pet toy 153 comprises a molded heavy-duty FDA grade non-toxic non-bitter rubber.

Preferably, the integral pet bed 100 is in a rectangular configuration, as shown. In alternative embodiments, the integral pet bed 100 is in a non-rectangular configuration (not shown). In addition, the preferred integral pet bed 100 ranges in size such that the integral pet bed 100 will fit within 24-54 inch deep dog crates.

Preferably, each of the plurality of molded joints 130 comprise molded cylindrical bulbous rims. In other embodiments, each of the plurality of molded joints 130 are in a spherical configuration.

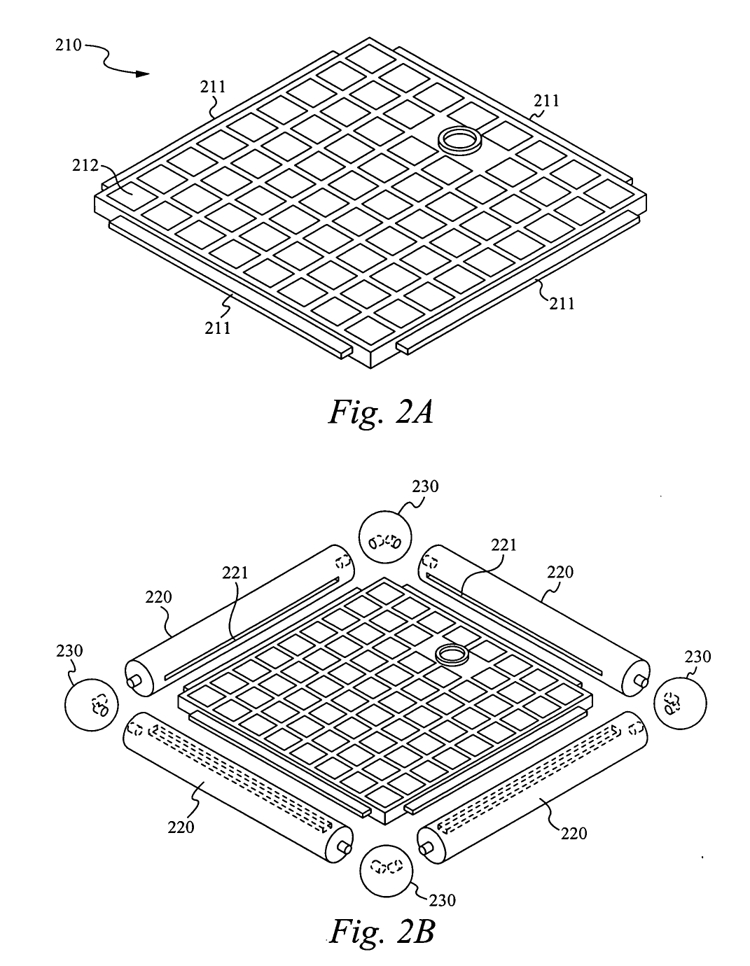

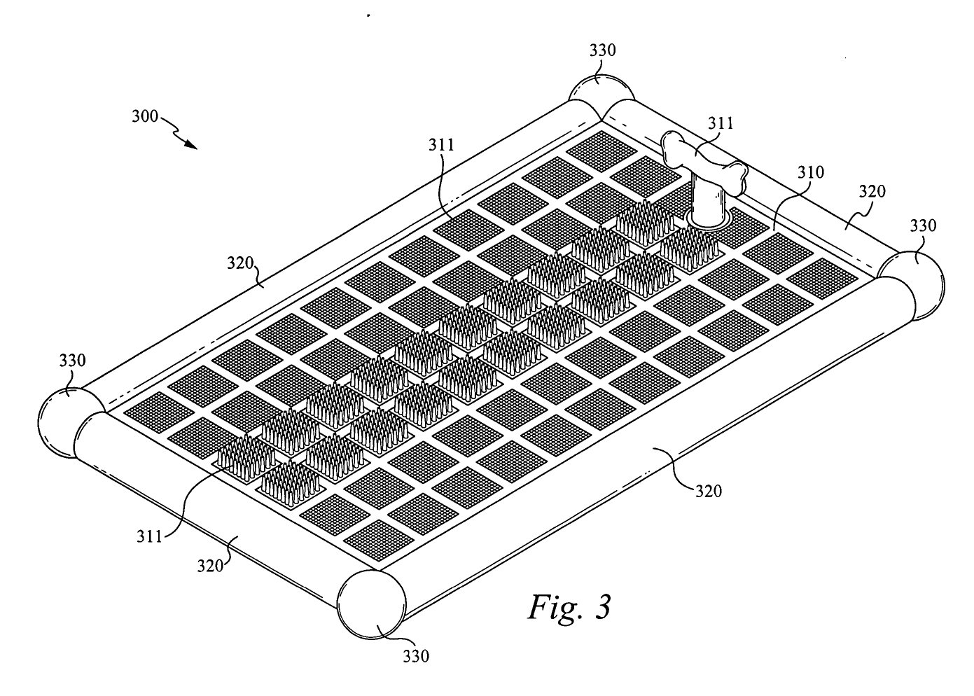

A chew-resistant pet bed 200 is illustrated in FIGS. 2A, 2B, and 2C. The pet bed 200 comprises a mattress 210, a plurality of rims 220, and a plurality of spherical joints 230. Specifically, FIG. 2A illustrates the mattress 210, FIG. 2B illustrates the mattress 210 with the plurality of rims 220 and the plurality of spherical joints 230, and FIG. 2C illustrates the pet bed 200 fully assembled. The mattress 210 comprises a homogeneous resilient non-toxic bitter material, a protrusion feature 211, and a plurality of insert sections 212. Each of the plurality of rims 220 comprise a channel feature 221. The channel feature 221 is configured to complementarily couple to the protrusion feature 211 of the mattress 210. Further, each of the plurality of spherical joints 230 are configured to couple to at least one of the plurality of rims 220 and the mattress 210. In alternative embodiments, each of the plurality of spherical joints are in a corner joint configuration. Preferably, the pet bed 200 ranges in size such that the pet bed 200 will fit within 24-54 inch deep dog crates (not shown). Preferably, at least one of the plurality of insert sections 212 comprise cloth (not shown); in other embodiments, at least one of the plurality of insert sections 212 comprise a chew-resistant pet toy (not shown), a plurality of bristles (not shown), or a combination thereof (not shown). Sample embodiments of the plurality of insert sections 212 are shown in FIGS. 4, 5, and 6.

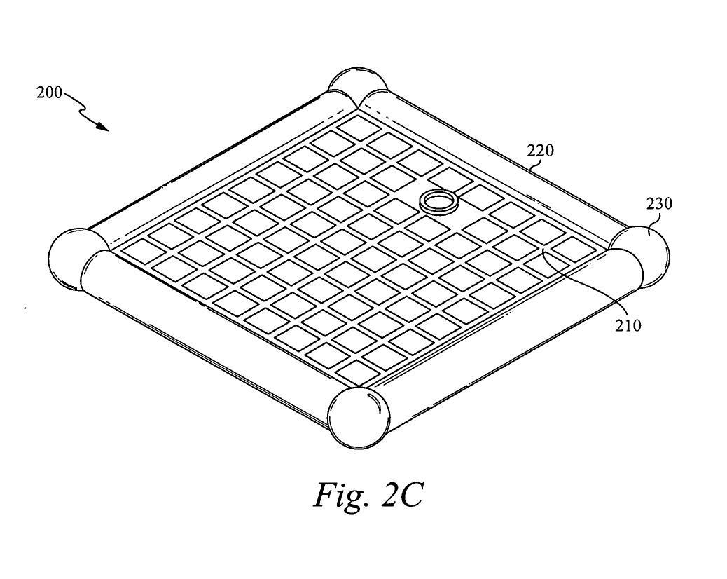

A chew-resistant pet bed 300 is illustrated FIG. 3. The pet bed 300 comprises a mattress subassembly 310. In alternative embodiments, the pet bed 300 comprises a pad (not shown) or a molded mattress (not shown). Regardless, of the embodiment, it should be understood that the pet bed is configured to hold a pet (not shown). The preferred pet bed 300 ranges in size such that the pet bed 300 will fit within 24-54 inch deep dog crates (not shown).

The mattress subassembly 310 comprises a plurality of insert sections 311. In another embodiment, the mattress subassembly (or pad, or molded mattress) further comprises a plurality of holes (not shown) each comprising an insert section 311. The pet bed 300 further comprises a casing subassembly 320. The casing subassembly 320 is configured to detachably couple to the mattress subassembly 310. The mattress subassembly 310 of the pet bed 300 is preferably in a generally rectangular configuration. In other embodiments, the mattress subassembly 310 is in a generally non-rectangular configuration. The non-rectangular configurations include, but are not limited to circular or polygonal configurations or combinations thereof. Further, the preferred insert sections 311 are in a generally rectangular configuration. However, in other embodiments, the insert sections 311 are in a generally non-rectangular configuration, including, but not limited to, circular or polygonal configurations or combinations thereof. In one embodiment, the insert sections 311 are in a square configuration with a size no larger than 4″×4″. It should be understood, however, that the insert sections 311 could be any size and the 4″×4″ embodiment merely serves as an example. It should also be understood that the insert sections 311 could comprise a single insert section (not shown). In one embodiment, the insert section 311 comprises cloth allowing for a pet to digest the portion of the insert section which is possibly chewed off or otherwise removed from the mattress. In other embodiments, the insert section 311 comprises bristles allowing for massaging, itching, or stimulation of the pet. While in another embodiment, the insert section 311 comprises a pet toy allowing for the pet to chew or play with the toy. Samples of these embodiments are illustrated in FIGS. 3, 4, and 5. In yet another embodiment, the insert sections 311 are removable, replaceable, and interchangeable by detachably coupling to the mattress subassembly 310.

The preferred casing subassembly 320 of the chew-resistant pet bed 300 comprises a plurality of bulbous corner subassemblies 330. In other embodiments, the plurality of bulbous corner subassemblies 330 are in a spherical configuration. In yet another embodiment, the corner subassemblies 330 comprise molded cylindrical bulbous rims. Further, the preferred pet bed 300 comprises a homogenous resilient non-toxic bitter material. In an embodiment, the homogenous resilient material comprises polyvinyl chloride (not shown). In another embodiment, the homogeneous resilient material comprises non-toxic bitter rubber (not shown). It should be understood, however, that the preferably homogenous resilient material comprises a material that is non-toxic, bitter, and chew-resistant. Further, in an embodiment, the components of the pet bed 300 comprise a hollowed core (not shown). The hollowed core provides added tensile strength. Preferably, the hollowed core comprises a plurality of holes to allow the air, water, or other liquids to escape.

In another embodiment, the pet bed 300 comprises a molded mattress (not shown), a molded frame (not shown), and a plurality of joints (not shown). In the alternative embodiment, the molded frame is configured to detachably couple to the molded mattress. The plurality of joints are each configured to detachably couple to the molded frame and to the molded mattress. Further, in yet another embodiment, the pet bed 300 further comprises a plurality of links (not shown) in addition to the plurality of joints. Each of the plurality of links comprise a fitted feature (not shown) configured to securely couple each of the plurality of links to the pad (not shown). Further, each of the plurality of joints comprise a complementary fitted feature configured to couple to the fitted feature thereby detachably coupling each of the plurality of joints to the plurality of links. In one embodiment, the fitted feature comprises a channel. In another embodiment, the fitted feature comprises a groove. Preferably, the fitted feature comprises a male fitting and the complementary fitted feature comprises a female fitting.

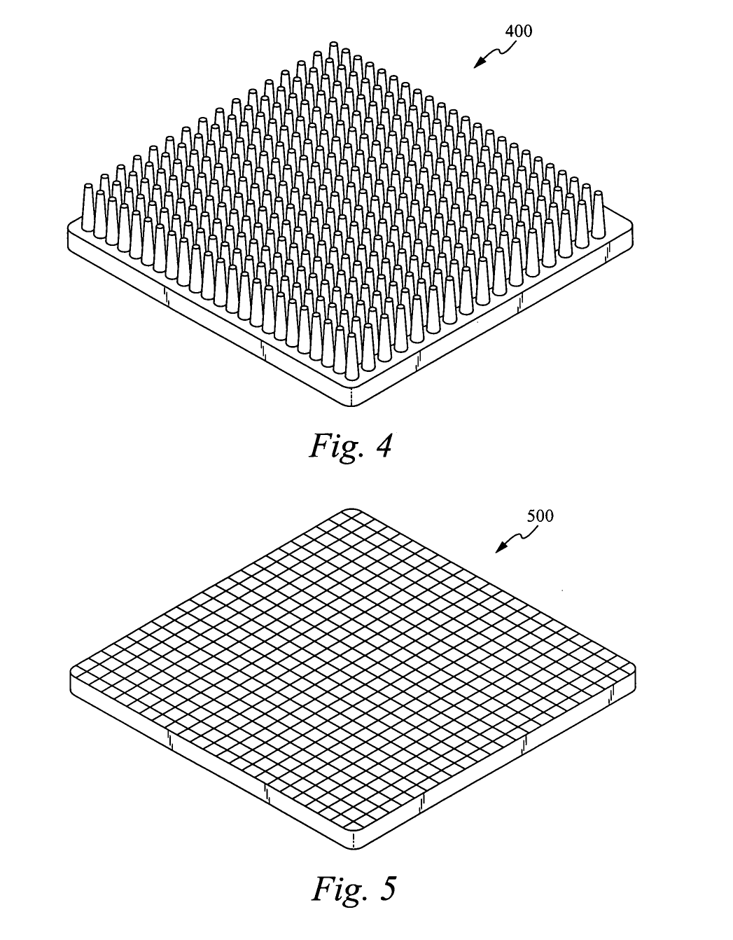

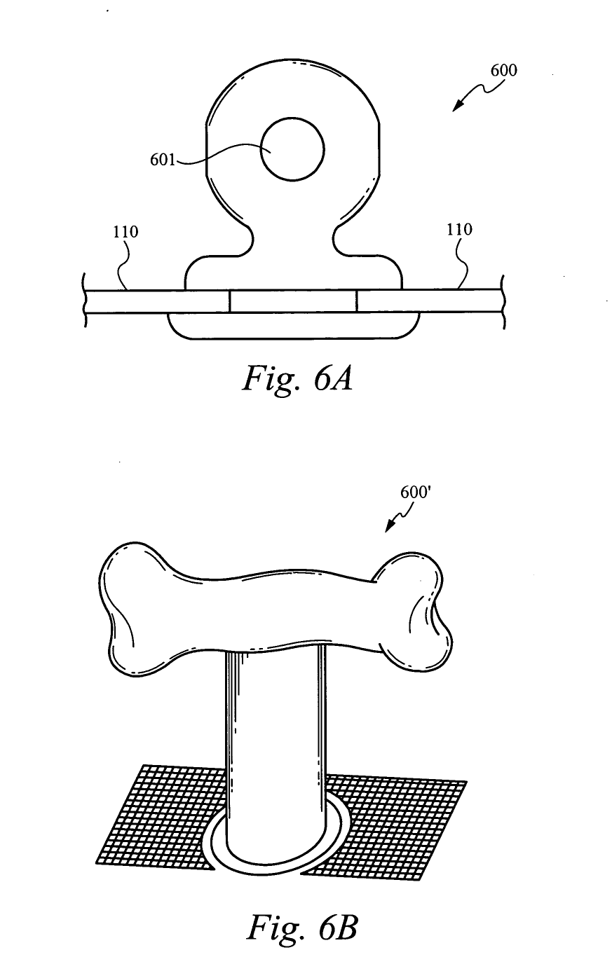

FIGS. 4, 5, and 6 illustrate sample embodiments of insert sections, described above as the plurality of insert sections 150, 212 or 311. FIG. 4 illustrates an insert 400 comprising rubber bristles. FIG. 5 illustrates an insert 500 comprising cloth. FIGS. 6A and 6B illustrate sample embodiments of a pet toy 600 and a pet toy 600′. In one embodiment of the pet beds described above, at least one of the inserts preferably comprises the cloth insert section 500. In other embodiments, at least one of the inserts comprise the rubber bristles insert section 400. In the preferred embodiment, at least one of the inserts comprises a pet toy insert section 600. In yet another embodiment, at least one of the inserts comprises a pet toy insert section 600′. The pet toy insert section 600 or 600′ is configured to detachably couple to the pet bed. Further, the pet toy insert section 600 or 600′ comprises a molded heavy-duty FDA grade non-toxic non-bitter rubber. Preferably, the pet toy insert 600 or 600′ each comprises a homogenous non-toxic non-bitter chew-resistant resilient material. The preferred pet toy insert 600 comprises a hole 601 configured to hold a pet treat (not shown) and is shown coupled to the molded mattress 110. Examples of a pet treat include, but are not limited to, a food product, or a chewable toy. In yet another embodiment, at least one of the insert sections 150, 212 or 311 comprise the rubber bristles insert section 400, the cloth insert section 500, the pet toy insert section 600 or 600′, or a combination thereof. It should be understood that the insert sections illustrated in FIGS. 4, 5, and 6 serve only as samples and do not limit the configurations or materials utilized.

The pet bed currently disclosed provides an improved chew-resistant pet bed that may be utilized for a wide range of pets. The pet bed provides both a soft comfortable sleeping surface, as well as components that are almost impermeable to chewing. The chew-resistant homogenous resilient non-toxic bitter material bounces back with each bite and retains its original strength and form keeping the pet bed intact. In addition, the non-toxic non-bitter pet toy serves to keep a pet entertained and provide an appropriate component to gnaw on. The current invention thus provides an ideal and safe bed for teething pets or pets who like to chew.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to one of ordinary skill in the art that the device of the present invention could be implemented in several different ways and the embodiments disclosed above are only exemplary of the preferred embodiment and the alternative embodiments of the invention and is in no way a limitation. It will be apparent to those skilled in the art that modifications may be made in the embodiment chosen for illustration without departing from the spirit and scope of the invention.

What is claimed is:

1. A chew-resistant pet bed comprising:
a. a mattress subassembly comprising a plurality of insert sections; and
b. a casing subassembly, wherein the casing subassembly is configured to detachably couple to the mattress subassembly.

2. The chew-resistant pet bed of claim 1, wherein the mattress subassembly is in a generally rectangular configuration.

3. The chew-resistant pet bed of claim 1, wherein the mattress subassembly is in a generally non-rectangular configuration.

4. The chew-resistant pet bed of claim 1, wherein the casing subassembly is in a generally rectangular configuration.

5. The chew-resistant pet bed of claim 1, wherein the casing subassembly is in a generally non-rectangular configuration.

6. The chew-resistant pet bed of claim 1, wherein the insert sections are in a generally rectangular configuration.

7. The chew-resistant pet bed of claim 1, wherein the insert sections are in a generally non-rectangular configuration.

8. The chew-resistant pet bed of claim 1, wherein the casing comprises a plurality of bulbous corner subassemblies.

9. The chew-resistant pet bed of claim 1, wherein the pet bed comprises a homogenous resilient non-toxic bitter material.

10. The chew-resistant pet bed of claim 9, wherein the homogenous resilient material comprises polyvinyl chloride.

11. An integral pet bed comprising:
a. a molded mattress;
b. a molded frame; and
c. a plurality of molded joints;
wherein the molded mattress, the molded frame, and each of the plurality of molded joints comprise a homogenous non-toxic bitter chew-resistant resilient material and are molded to form the integral pet bed.

12. The integral pet bed of claim 11, wherein the integral pet bed is in a rectangular configuration.

13. The integral pet bed of claim 11, wherein the integral pet bed is in a non-rectangular configuration.

14. The integral pet bed of claim 11, wherein the integral pet bed ranges in size such that the integral pet bed will fit within 24-54 inch deep dog crates.

15. The integral pet bed of claim 11, wherein each of the plurality of molded joints comprise molded cylindrical bulbous rims.

16. The integral pet bed of claim 11, wherein each of the plurality of molded joints are in a spherical configuration.

17. The integral pet bed of claim 11, wherein the molded mattress, the molded frame, and each of the plurality of molded joints comprise a hollowed core.

18. The integral pet bed of claim 11, wherein the molded mattress further comprises a plurality of holes each comprising a molded insert.

19. The integral pet bed of claim 18, wherein at least one of the molded insert comprises cloth.

20. The integral pet bed of claim 18, wherein at least one of the molded insert comprises rubber bristles.

21. The integral pet bed of claim 18, wherein at least one of the molded insert comprises a pet toy configured to detachably couple to at least one of the plurality of holes.

22. The integral pet bed of claim 18, wherein at least one of the molded insert comprises cloth, rubber bristles, a pet toy, or a combination thereof.

23. The integral pet bed of claim 21, wherein the pet toy comprises a molded heavy-duty FDA grade non-toxic non-bitter rubber.

24. The integral pet bed of claim 21, wherein the pet toy comprises a homogenous non-toxic non-bitter chew-resistant resilient material and a hole configured to hold a pet treat.

25. The integral pet bed of claim 24, wherein the pet treat comprises a food product.

26. The integral pet bed of claim 24, wherein the pet treat comprises a chewable toy.

27. A pet bed comprising:
a. a molded mattress;
b. a molded frame comprising a non-toxic bitter chew-resistant resilient material, wherein the molded frame is configured to detachably couple to the molded mattress; and
c. a plurality of joints each configured to detachably couple to the molded frame and to the molded mattress.

28. The pet bed of claim 27, wherein the pet bed is in a rectangular configuration.

29. The pet bed of claim 27, wherein the pet bed is in a non-rectangular configuration.

30. The pet bed of claim 27, wherein the pet bed ranges in size such that the pet bed will fit within 24-54 inch deep dog crates.

31. The pet bed of claim 27, wherein each of the plurality of joints comprise molded cylindrical bulbous rims.

32. The pet bed of claim 27, wherein each of the plurality of joints are in a spherical configuration.

33. The pet bed of claim 27, wherein the components of the pet bed comprise a hollowed core.

34. The pet bed of claim 27, wherein the molded mattress further comprises a plurality of holes each comprising an insert.

35. The pet bed of claim 34, wherein at least one of the insert comprise cloth.

36. The pet bed of claim 34, wherein at least one of the insert comprise rubber bristles.

37. The pet bed of claim 18, wherein at least one of the insert comprises a pet toy configured to detachably couple to at least one of the plurality of holes.

38. The pet bed of claim 34, wherein at least one of the insert comprise cloth, rubber bristles, a pet toy configured to detachably couple to at least one of the plurality of holes, or a combination thereof.

39. The pet bed of claim 37, wherein the pet toy comprises a molded heavy-duty FDA grade non-toxic non-bitter rubber.

40. The pet bed of claim 37, wherein the pet toy comprises a hole configured to hold a pet treat.

41. The pet bed of claim 40, wherein the pet treat comprises a food product.

42. The pet bed of claim 40, wherein the pet treat comprises a chewable toy.

43. A pet bed comprising:
a. a pad configured to hold a pet;
b. a plurality of links, wherein each of the plurality of links comprise a fitted feature configured to securely couple each of the plurality of links to the pad; and
c. a plurality of joints, wherein each of the plurality of joints comprise a complementary fitted feature configured to couple to the fitted feature thereby detachably coupling each of the plurality of joints to the plurality of links;
wherein the pad, plurality of links, and plurality of joints each comprise a chew-resistant material.

44. The pet bed of claim 43, wherein the fitted feature comprises a channel.

45. The pet bed of claim 43, wherein the fitted feature comprises a groove.

46. The pet bed of claim 43, wherein the fitted feature comprises a male fitting and the complementary fitted feature comprises a female fitting.

47. The pet bed of claim 43, wherein the chew-resistant material comprises a homogeneous resilient non-toxic bitter material.

48. The pet bed of claim 43, wherein the homogeneous resilient material comprises non-toxic bitter rubber.

49. The pet bed of claim 43, wherein the pad further comprises a plurality of insert sections.

50. The pet bed of claim 49, wherein at least one of the plurality of insert sections is configured to detachably couple to the pad.

51. A chew-resistant pet bed comprising:
a. a mattress comprising a homogeneous resilient material, a protrusion feature, and a plurality of insert sections;
b. a plurality of rims each comprising a channel feature, wherein the channel feature is configured to complementarily couple to the protrusion feature of the mattress; and
c. a plurality of spherical joints each configured to couple to at least one of the plurality of rims and the mattress.

52. The chew-resistant pet bed of claim 51, wherein the pet bed ranges in size such that the pet bed will fit within 24-54 inch deep dog crates.

53. The chew-resistant pet bed of claim 51, wherein at least one of the plurality of insert sections comprise cloth.

54. The chew-resistant pet bed of claim 51, wherein at least one of the plurality of insert sections is configured to secure a chew-resistant pet toy.

55. The chew-resistant pet bed of claim 51, wherein at least one of the plurality of insert sections comprise a plurality of bristles.

56. The chew-resistant pet bed of claim 51, wherein at least one of the plurality of insert sections is configured to detachably couple to the mattress.

57. The chew-resistant pet bed of claim 51, wherein the plurality of spherical joints are in a corner joint configuration.

58. A pet bed comprising:
a. a pad configured to hold a pet;
b. a plurality of links, wherein each of the plurality of links comprise a fitted feature configured to securely couple each of the plurality of links to the pad; and
c. a plurality of joints, wherein each of the plurality of joints comprise a complementary fitted feature configured to couple to the fitted feature thereby detachably coupling each of the plurality of joints to the plurality of links;
wherein the plurality of links and the plurality of joints each comprise a hollow core.

59. The pet bed of claim 58, wherein the fitted feature comprises a channel.

60. The pet bed of claim 58, wherein the fitted feature comprises a groove.

61. The pet bed of claim 58, wherein the fitted feature comprises a male fitting and the complementary fitted feature comprises a female fitting.

62. The pet bed of claim 58, wherein the chew-resistant material comprises a homogeneous resilient non-toxic bitter material.

63. The pet bed of claim 58, wherein the homogeneous resilient material comprises non-toxic bitter rubber.

64. The pet bed of claim 58, wherein the pad further comprises a plurality of insert sections.

65. The pet bed of claim 64, wherein at least one of the plurality of insert sections is configured to detachably couple to the pad.
